(19) United States
(12) Patent Application Publication
(10) Pub. No.: US 2020/0242594 A1
(43) Pub. Date: Jul. 30, 2020

(54) SYSTEMS AND METHODS FOR SPECIALIZED CRYPTOCURRENCY TRANSACTIONS

(71) Applicant: NTH ROUND, INC., Wayne, PA (US)

(72) Inventors: Christopher F. MCCONNELL, Berwyn, PA (US); Tracy AUERBACH, Haverford, PA (US)

(21) Appl. No.: 16/648,407

(22) PCT Filed: Sep. 18, 2018
(86) PCT No.: PCT/US2018/051549

§ 371 Date: Mar. 18, 2020

Related U.S. Application Data
(60) Provisional application No. 62/560,018, filed on Sep. 18, 2017.

(51) Int. Cl. G06Q 20/38; G06Q 20/06; G06Q 20/36; G06Q 10/10; G06Q 40/04; G06Q 30/00

(52) U.S. Cl. CPC G06Q 20/381; G06Q 20/0655; G06Q 20/3678; G06Q 10/10; G06Q 2220/00; G06Q 20/3825; G06Q 20/3829; G06Q 20/3672; G06Q 30/018; G06Q 40/04

(57) ABSTRACT

A method for specialized cryptocurrency transactions may comprise determining that an entity comprises a member of a class. An account associated with the cryptocurrency or a blockchain may be generated for the entity. At least a portion of a unit of the cryptocurrency may be transferred to the entity. A transaction may be generated to transfer units of the cryptocurrency to a recipient. It may be determined that the recipient is a member of the class associated with the cryptocurrency. If the recipient is a member, the units may be transferred to the recipient. The transaction may be added to the blockchain. If the recipient is not a member, the units may be exchanged for units of another cryptocurrency. The units of the other cryptocurrency may be transferred to the recipient.

### BACKGROUND

With public interest in cryptocurrencies mounting and Initial Coin Offerings (ICO's) occurring with increasing frequency, regulatory bodies, such as the Securities and Exchanges Commission (SEC), have felt the need to address the new market.

The SEC has relatively strict rules regarding public and private placements of securities. Currently, for private and/or smaller placements, the SEC offers two paths which reduce or even eliminate registration requirements: Reg D and Reg A+. A primary designation that often must be met is that most or all of the investors should be Accredited Investors. Firms doing private placements, and more recently Initial Coin Offerings (ICOs), often need to limit their offerings to Accredited Investors. The SEC provides clear guidance as to the qualifications for an Accredited Investor. For private individuals, this means affirming relatively high income and/or relatively high net worth. Generally, prospective investors are provided an Accredited Investor questionnaire which they can fill out and sign as means of establishing that they are Accredited Investors.

Collecting the identities of these prospective participants, qualifying them as Accredited Investors, and then tracking their identities to funds received is a relatively complex task. As time goes by, the information collected may become sufficiently aged that prospective investors will need to reaffirm their status as Accredited Investors before participating in another private offering. This invites renewed challenges and renewed expense.

A second problem emerges after the offering (ICO) finishes, in what is generally called the secondary market, where original investors in a private offering may wish to sell their coins/tokens or securities. The SEC also has regulations covering the resale of private securities, generally including a one year holding period, and the restriction that private securities only may be sold to another Accredited Investor. This raises more potential issues and/or complications, especially with regard to ICOs, where a key presumed advantage of a coin offering often includes ready tradability (liquidity and or fungibility) of issued coins.

### SUMMARY

What is needed is a straightforward, reliable, and comprehensive method for facilitating the qualification process for prospective participants in private offerings, especially ICOs. An added benefit would include facilitating the qualification process for prospective purchasers in the secondary market for private securities, including coins, where securities regulations also may apply. A further benefit would be a system that maintains itself without arduous oversight from a central authority and/or third party service-provider.

A specialized cryptocurrency may be created for a particular class of individuals or entities, such as Accredited Investors. Possession of the cryptocurrency may be limited to individuals or entities of the class. The cryptocurrency system may be self-authenticating in that possession of units of the cryptocurrency may prove qualification as a member of the class.

Units of the specialized cryptocurrency may be traded on a blockchain. A smart contract may be generated that may configured to determine whether parties to a transaction comprise members of a class associated with the specialized cryptocurrency. Transactions comprising an attempted transfer of units of the specialized cryptocurrency may be accepted or added to the blockchain, such as by the smart contract or by nodes, if the transferee and the transferor are both determined to be members of the class. Units of the specialized cryptocurrency may be exchanged for or converted to units of other cryptocurrencies.

The self-authenticating methods may reduce resources required for verifying the qualification of parties to transactions or potential participants as members of a class. Therefore, the methods may facilitate tradability of the specialized cryptocurrency, such as liquidity and fungibility of issued coins or tokens of the cryptocurrency. The methods may be scalable and adapted to accommodate large numbers of potential participants in ICO's and in the secondary market.

Additionally, the methods may maintain anonymity of the parties. Accounts or wallets, rather than other personal information, may be used to determine qualification of a party as a member of a class, as the accounts or wallets may hold units of the specialized cryptocurrency, indicating that the party comprises a member of the class. Also, the methods may preclude or streamline the re-verification of qualifications of members of a class. Accounts may prompt parties to confirm qualification as members of the class at time intervals. Initiation of transactions may trigger requests for the parties to confirm qualification as members of the class. The methods may reduce or avoid the need for oversight by a central authority or the need to enlist services of a third party.

### BRIEF DESCRIPTION OF THE DRAWINGS

The following drawings illustrate generally, by way of example, but not by way of limitation, various examples discussed in the present disclosure. In the drawings:

FIG. 1 shows an example method.

FIG. 2 shows an example system architecture.

### DETAILED DESCRIPTION

A specialized cryptocurrency for a class of individuals or entities may be generated. For example, the class of individuals or entities may comprise Accredited Investors or Qualified Investors. Possession of the cryptocurrency may be limited to individuals or entities of the class. Therefore, possession of units, such as coins or tokens, of the cryptocurrency may indicate that the individual or entity in possession of the cryptocurrency is of the class. Based on possession of units of the cryptocurrency, it may be determined that the individual or the entity in possession of the cryptocurrency is of the class.

An entity or individual receiving or buying units of the cryptocurrency may determine that the seller or transferor of the units comprises an individual or entity of the class without the need to perform additional inquiry into the qualifications of the individual or entity. An individual or an entity who is in possession of units of the cryptocurrency may transfer or sell units to a member of the class of individuals or entities associated with the cryptocurrency. The potential transferor may determine that the potential transferee comprises a member of the class based on a determination that the potential transferee is already in possession of at least a unit or a fraction of a unit of the cryptocurrency. For example, the potential transferor may determine that the potential transferee holds at least a unit or a portion of a unit in a wallet or a blockchain account. The specialized cryptocurrency may comprise a self-authenticating method of transferring units of the cryptocurrency. Reference to units of the cryptocurrency should be understood to comprise whole units, portions of units, and fractions of units, or other denominations of the cryptocurrency.

An individual or entity seeking eligibility to trade in the specialized cryptocurrency may establish that they qualify as a member of the class. For example, the individual or entity may provide personal or financial information to establish that they qualify as a member of the class. The information may be provided to a trusted third party, a central authority, a regulatory body, or an issuer of the cryptocurrency, as an example. The individual or the entity may provide the information in a questionnaire. The individual or the entity may provide the information online or by an automated process. Documentation may be provided to establish qualification. Credibility of the individual or the entity may be used to qualify the individual or the entity as a member of the class.

Based on a determination that the individual or the entity qualifies as a member of the class, a wallet or an account may be generated. The account may comprise a blockchain account or an account associated with the specialized cryptocurrency. A key may be generated for the account. The key may comprise a cryptographic key. The key may comprise a pair of keys, such as a public key and a private key. The public key may be known as the key of a member of the class. The private key may be secret and only known to the entity or the individual. The public key and the private key may be used to encrypt data, such as a transaction. The public key and the private key may be used to decrypt data that has been encrypted using the other key of the pair. The key may be used to digitally sign transactions of the specialized cryptocurrency, such as on a blockchain. The key may be used as to identify the individual or the entity, while concealing a name or other personal information of the individual or the entity.

Based on the determination that the individual or the entity qualifies as a member of the class, a pre-existing wallet or account associated with the individual or the entity may be registered as qualified. Alternatively or additionally, based on a determination that the individual or entity qualifies as a member of the class, the individual or entity may receive a unit or a portion of the unit of the specialized cryptocurrency, such as a “seed amount” of the cryptocurrency. Possession of the unit or the portion of the unit, even in a nominal amount, may indicate that the individual or the entity qualifies as a member of the class. Potential transferors or transferees of the cryptocurrency may determine that the individual or the entity comprises a member of the class by determining that the individual or the entity possesses the unit or the portion of the unit of the cryptocurrency.

Determination that an individual or an entity in possession of the specialized cryptocurrency qualifies as a member of the class associated with the cryptocurrency may be performed after initial verification of the individual or the entity. Re-verification may be performed on a schedule, such as at time intervals or periods. For example, once every X days, weeks, months, or years, the qualification of individual or the entity may be re-verified, where X may comprise a selected number. An account associated with the individual or entity may be configured to prompt, at set time intervals, the individual or entity to confirm qualification as a member of the class. Re-verification may be triggered by an event. For example, qualification of the individual or the entity as a member of the class may be verified based on the individual or the entity transferring or initiating a transfer of units of the cryptocurrency.

The re-verification process may be similar to the process used to initially qualify the individual or the entity as a member of the class. The re-verification process may comprise transmitting, to the individual or the entity, a request to confirm qualification as a member of the class. The request may comprise a prompt for an electronic signature or fingerprint of the individual or the entity. The request may comprise a prompt to provide biometric data associated with the individual or the entity, such as based on facial recognition technology. The individual or the entity may respond by confirming that the individual or the entity qualifies as a member of the class.

Re-verification of the an individual or an entity in possession of units of the specialized cryptocurrency as a member of the class may determine that the individual or the entity no longer qualifies a member of the class. The individual or the entity may not respond to requests for confirmation of qualification as a member of the class. If it is determined or it cannot be determined that the individual or the entity continues to qualify as a member of the class, the units of the cryptocurrency held by the individual or the entity may be transferred to a coin exchange. The units may be converted to units of another cryptocurrency, such as bitcoin, ethereum, or litecoin. The individual or the entity may not be able to receive additional units of the cryptocurrency.

Transactions in the specialized cryptocurrency may be governed. For example, accounts for individuals or entities in possession of the specialized cryptocurrency may be generated. The accounts may be associated with a distributed ledger generated for the specialized cryptocurrency or on a distributed ledger associated with other cryptocurrencies. The distributed ledger may comprise a blockchain. Parties may use the accounts to generate transactions on the blockchain. The transactions may comprise the transfer of units of the specialized cryptocurrency. If the accounts of the parties to a transaction are determined to comprise accounts associated with members of the class, the transaction may be accepted and recorded on the blockchain. If one or more accounts of the parties to the transaction are not determined be associated with a member of the class, the transaction may not be accepted and may not be recorded on the blockchain. If the transaction is not accepted or recorded on the blockchain, the units of the cryptocurrency that are the subject of the transaction may not be transferred. Determining that an account is associated with a member of the class may comprise determining that the account is in possession of a unit or a portion of a unit of the cryptocurrency.

The transactions may be governed by nodes of the blockchain, such as computing devices or a network of computing devices that build the blockchain. The nodes may determine whether the accounts or parties are associated with the class. The nodes may determine, such as based on determination that the accounts or parties are associated with the class, to accept or record transactions on the blockchain. Alternatively or in addition, the blockchain may comprise a smart contract. The smart-contract may comprise a code recorded on the blockchain. The smart contract may comprise an operation run on the blockchain or executed by the blockchain. The smart contract may be configured to determine whether the accounts or the parties to a transaction of the cryptocurrency comprise accounts or parties associated with the class. The smart contract may be configured to accept or record, such as based on the determination that the accounts or parties are associated with the class, the transactions on the blockchain.

If one or more accounts or parties to a transaction of the cryptocurrency are determined to not be associated with the class, an event may be triggered. For example, the one or more parties or parties associated with the one or more accounts may be re-verified for qualification as a member of the class. As another example, units of the cryptocurrency that are the subject of the transaction may be converted to another cryptocurrency or coin exchange. One or more nodes of the blockchain or the smart contract may cause the event.

A transaction may be generated on the blockchain to convert one or more units of another cryptocurrency to the specialized currency and transfer the converted units. The transferor or sender may not comprise a member of the class. Based on a determination that the transferee or recipient comprises a member of the class, such as based on an account of the transferee or recipient, the one or more units may be converted to the specialized currency and transferred to the transferee or recipient. One or more nodes or the smart contract may perform the conversion of the one or more units to the specialized currency. A second transaction may be generated based on the initial transaction to convert or transfer the units. The conversion may use a coin exchange.

The transferee or recipient may not comprise a member of the class. Based on a determination that the transferor or sender does not comprise a member of the class, such as based on an account of the transferor or sender, one or more units may be converted to another cryptocurrency and transferred to the transferee or recipient. One or more nodes or the smart contract may perform the conversion of the one or more units to the other cryptocurrency. A second transaction may be generated based on the initial transaction to convert or transfer the units. The conversion may use a coin exchange.

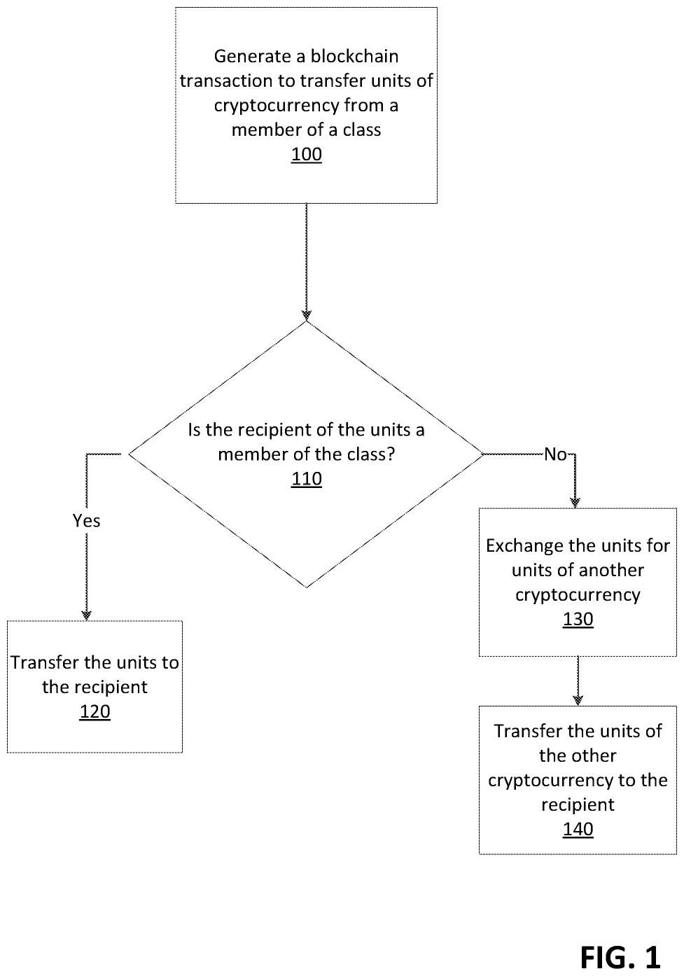

FIG. 1 shows an example method of managing transactions of specialized cryptocurrency on a blockchain. At step 100, a member of a class associated with specialized cryptocurrency may generate a transaction to transfer one or more units (e.g., whole units, fractions of a unit, denominations of units) of the specialized cryptocurrency. The transaction may indicate one or more transferees or recipients of the one or more units. The transaction may indicate an account of the transferee or recipient. The transaction may comprise an indication of a sender or a transferor of the units.

The transaction may comprise a transaction fee. The transaction fee may comprise one or more units of cryptocurrency, such as of a cryptocurrency. The transaction fee may comprise an incentive for one or more nodes of the blockchain to validate the transaction or add the transaction to the blockchain. The transaction fee may be transferred to a node that validates or “mines” the transaction. Validating the transaction may comprise the process in step 110.

The transaction may comprise instructions. For example, the instructions may indicate another cryptocurrency that the units of the specialized cryptocurrency may be converted to or exchanged for, such as if it is determined that the recipient is not a member of the class and cannot be in possession of the specialized cryptocurrency. The instructions may comprise an indication to generate another transaction. The instructions may comprise a time frame for the transaction, such as an expiration date or time. The instructions may comprise a reference to another blockchain transaction.

The transaction may be generated using a computing device. For example, the transaction may be generated using a user device. The user device may transmit the transaction to the blockchain. The computing device may comprise, for example, a personal computer, a desktop computer, a laptop computer, a tablet device, a mobile phone, a personal digital assistant, or an Internet of Things (IoT) device.

At step 110, it may be determined that the one or more transferees or recipients of the transaction comprises a member of the class. For example, an account or wallet of the transferee may be used to determine whether the transferee comprises a member of the class. Determining that the transferee comprises a member of the class may comprise determining that the transferee is in possession of a unit of the specialized cryptocurrency. A database of members of the class or database of individuals or entities that have been authorized to possess the specialized cryptocurrency may be used to determine whether the transferee comprises a member of the class. A database of members of the class or database of individuals or entities that have been authorized to possess the specialized cryptocurrency may be used to determine whether the transferee comprises a member of the class. The determination may be performed by one or more nodes of the blockchain or by a smart contract of the blockchain.

It may be determined that the transferor or sender of the transaction comprises a member of the class. For example, an account or wallet of the transferor may be used to determine whether the transferor is in possession of the units of the specialized cryptocurrency. A database of individuals or entities that have been verified as members of the class may be used to determine whether the transferor comprises a member of the class. A database of members of the class or database of individuals or entities that have been authorized to possess the specialized cryptocurrency may be used to determine whether the transferor comprises a member of the class. The determination may be performed by one or more nodes of the blockchain or by a smart contract of the blockchain.

At step 120, if it is determined that one or more of the transferees or recipient comprises a member of the class, the one or more units may be transferred to the transferee. The units may be transferred to the transferee based on the determination that the transferor comprises a member of the class. The transaction may be accepted on the blockchain. The transaction may be added or recorded to the blockchain. Adding the transaction to the blockchain may comprise publishing, sharing, or transmitting an indication of the transaction to other nodes in a distributed system associated with the blockchain. Adding the transaction to the blockchain may comprise adding the transaction to a block comprising a plurality of transactions and adding the block to the blockchain. The one or more units may be transferred to an account or a wallet associated with the transferee.

At step 130, if it is determined that one or more of the transferees or recipients does not comprise a member of the class, the transaction may not be accepted. If it is determined that the transferor or the sender does not comprise a member of the class, the transaction may not be accepted. The transaction may not be added or recorded on blockchain. For example, the transaction may remain in a pool of transactions that have not been added by the blockchain. The transaction may be pruned from the pool.

If it is determined that one or more of the transferees or recipients does not comprise a member of the class, one or more units may be exchanged or converted for units of another cryptocurrency. The units may be exchanged automatically or based on a request from the transferor or the transferee. The transaction may comprise an indication of a cryptocurrency to exchange or convert the units of the specialized cryptocurrency. The exchange or conversion may be performed by one or more nodes of the blockchain or by a smart contract of the blockchain. Exchanging or converting the units may comprise generating another transaction. The new transaction may be generated automatically, such as by the nodes or the smart contract. An individual or entity in possession of units of the other cryptocurrency may be a party to the new transaction. The party to the new transaction may comprise a member of the class, such as a member who is in possession of both the specialized cryptocurrency and the other cryptocurrency.

The units of the specialized currency may be converted or exchanged using a coin exchange. The coin exchange may comprise a market place or a third-party service provider that facilitates the trade of units of cryptocurrencies, other currencies, such as national currencies, and other assets. The coin exchange may determine exchange rates of units of cryptocurrencies and other currencies.

At step 140, the units of the other cryptocurrency may be transferred to the one or more transferees or recipients. The units of the other cryptocurrency may be transferred to an account or wallet associated with the transferee. A transaction transferring the units of the other cryptocurrency may be accepted by the blockchain or added to the blockchain. A new transaction may be generated to transfer the units of the other cryptocurrency to the transferee. The new transaction may be accepted by the blockchain or added to the blockchain. The new transaction may be generated by one or more nodes of the blockchain or by a smart contract of the blockchain.

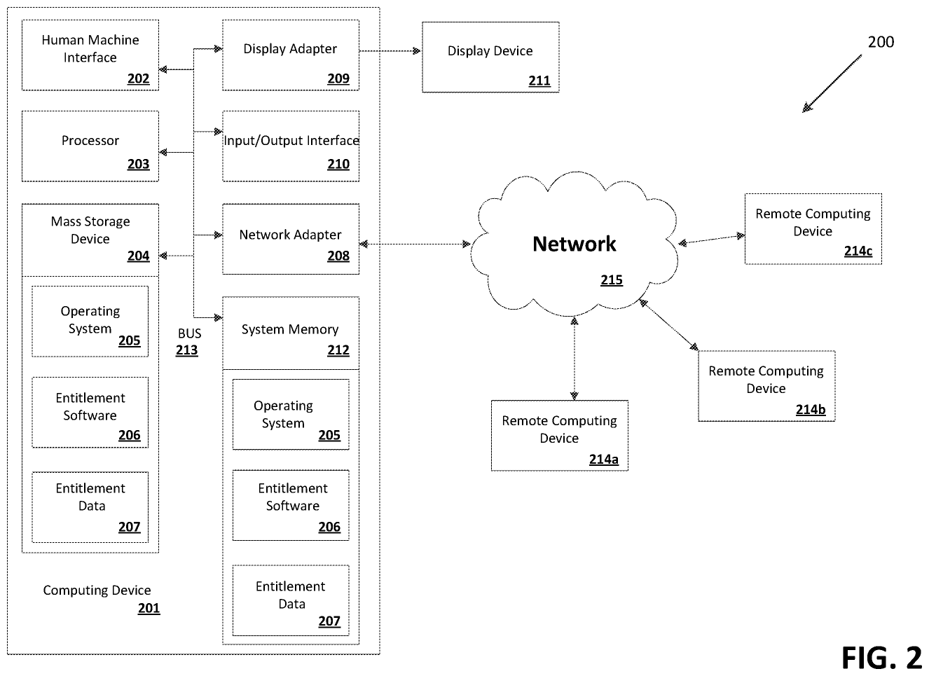

FIG. 2 shows a block diagram illustrating an exemplary operating environment 200 for performing the disclosed methods of transacting in a specialized cryptocurrency. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems may be performed by software components. The disclosed systems and methods may be described in the general context of computer-executable instructions, such as program modules, being executed by one or more computers or other devices. Generally, program modules comprise computer code, routines, programs, objects, components, data structures, etc. that performs particular tasks or implement particular abstract data types. The disclosed methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods disclosed herein may be implemented via a general-purpose computing device in the form of a computing device 201. The components of the computing device 201 may comprise, but are not limited to, one or more processors or processing units 203, a system memory 212, and a system bus 213 that couples various system components including the processor 203 to the system memory 212. In the case of multiple processing units 203, the system may utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description may also be implemented over a wired or wireless network connection and each of the subsystems, including the processor 203, a mass storage device 204, an operating system 205, entitlement software 206, entitlement data 207, a network adapter 208, system memory 212, an Input/Output Interface 210, a display adapter 209, a display device 211, and a human machine interface 202, may be contained within one or more remote computing devices 214a,b,c at physically separate locations, connected through buses of this form, in effect implementing a fully distributed system.

The computing device 201 typically comprises a variety of computer readable media. Exemplary readable media may be any available media that is accessible by the computing device 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as entitlement data 207 and/or program modules such as operating system 205 and entitlement software 206 that are immediately accessible to and/or are presently operated on by the processing unit 203.

In another aspect, the computing device 201 may also comprise other removable/non-removable, volatile/non-volatile computer storage media. By way of example, FIG. 12 illustrates a mass storage device 204 which may provide non-volatile storage of computer code, computer readable instructions, data structures, program modules, and other data for the computing device 201. For example and not meant to be limiting, a mass storage device 204 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 204, including by way of example, an operating system 205 and entitlement software 206. Each of the operating system 205 and entitlement software 206 (or some combination thereof) may comprise elements of the programming and the entitlement software 206. Entitlement data 207 may also be stored on the mass storage device 204. Entitlement data 207 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

In another aspect, the user may enter commands and information into the computing device 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices may be connected to the processing unit 203 via a human machine interface 202 that is coupled to the system bus 213, but may be connected by other interface and bus structures, such as a parallel port, game port, an IEEE 294 Port (also known as a Firewire port), a serial port, or a universal serial bus (USB).

In yet another aspect, a display device 211 may also be connected to the system bus 213 via an interface, such as a display adapter 209. It is contemplated that the computing device 201 may have more than one display adapter 209 and the computer 201 may have more than one display device 211. For example, a display device may be a monitor, an LCD (Liquid Crystal Display), or a projector. In addition to the display device 211, other output peripheral devices may comprise components such as speakers (not shown) and a printer (not shown) which may be connected to the computing device 201 via Input/Output Interface 210. Any step and/or result of the methods may be output in any form to an output device. Such output may be any form of visual representation, including, but not limited to, textual, graphical, animation, audio, tactile, and the like. The display 211 and computing device 201 may be part of one device, or separate devices.

The computing device 201 may operate in a networked environment using logical connections to one or more remote computing devices 214a,b,c. By way of example, a remote computing device may be a personal computer, portable computer, a smart phone, a server, a router, a network computer, a peer device or other common network node, and so on. Logical connections between the computing device 201 and a remote computing device 214a,b,c may be made via a network 215, such as a local area network (LAN) and a general wide area network (WAN). Such network connections may be through a network adapter 208. A network adapter 208 may be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of entitlement software 206 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The present disclosure comprises at least the following non-limiting examples and implementations. Such description is not intended to limit the scope of the disclosure, but instead to provide an illustrative embodiment in accordance with the present disclosure.

The present disclosure may provide a cryptocurrency only for Accredited Investors. For the purposes of this document, we call this cryptocurrency (these “coins”) AZUR. AZUR only could be obtained (e.g., purchased), held (e.g., in a “wallet” or blockchain account), and disposed (e.g., transferred or sold) from, by, and to other Accredited Investors. Note that we use the term Accredited Investor herein as one class of individuals/entities; however, other classes easily can be envisioned. For example Qualified Investors (a higher standard) could be associated just as easily with a specialized cryptocurrency. We will continue to use the term Accredited Investor for ease of understanding; however, nothing herein should imply that we are limiting this invention to the Accredited Investor class. Any select group of individuals and/or entities, of any standing, high or low, might benefit from this invention.

In an aspect, AZUR is the currency of Accredited Investors. Upon receiving AZUR, the recipient can feel assured that it came from another Accredited Investor. This vastly simplifies, even eliminates, the burden of a recipient needing to verify that the sender meets the qualifications of an Accredited Investor. The AZUR coin effectively embeds the fact that the sender is an Accredited Investor.

Additionally or alternatively, an AZUR holder (who already must be an Accredited Investor) only can send AZUR to another Accredited Investor (or to an issuer of private securities, e.g., an ICO issuer). This means that the sender need not worry about being qualified by the recipient as an Accredited Investor, since holding AZUR already establishes that qualification. This dramatically reduces the amount of forms, paperwork, and signatures generally associated with participating in a private placement or ICO.

Almost as fundamental as the notion that all AZUR holders, senders, and receivers must be Accredited Investors is an important logical corollary: any entity that currently holds AZUR is an Accredited Investor. So, a straightforward way to determine if a potential AZUR recipient is an Accredited Investor is simply to check and see if they already hold AZUR. If they do, then he or she is (or certainly was recently) an Accredited Investor. The AZUR can be transferred to anyone that already holds AZUR, with comfort and assurance that compliance rules are being met. A subtle, but important point to make is that a new, and previously unidentified, individual or entity can be “stamped” as an Accredited Investor simply by placing a “seed” amount of AZUR in their wallet or blockchain account. This vastly simplifies the process for verifying the qualification status of a potential recipient. Just look and see if they already hold AZUR. If so, they are an Accredited Investor.

We should pause here, and note that all AZUR holders periodically will need to re-establish their qualifications as an Accredited Investors, especially if they wish to transfer their AZUR. This “refreshing” of Accredited Investor status could be done on a time schedule (say, every six months), and/or prompted by an event (say, wishing to initiate a transfer). The process for re-establishing Accredited Investor status may be significantly simpler than the initial qualification process, described below, for establishing Accredited Investor status. For example it could be as simple as encountering a message on a web page or mobile site that says, “Please verify that your financial status has not changed and that you remain as Accredited Investor.” For security, responding to this message may require an electronic signature or fingerprint or facial recognition or other similar measure.

In the event that an AZUR holder no longer can confirm Accredited Investor status, then that holder will be required to transfer their AZUR to a coin exchange (see below) for a similar value of a general currency such as Ether or Bitcoin. That holder no longer will be able to receive, hold, or send AZUR, except for the requisite coin exchange.

For the initial qualification process, we envision a similar questionnaire to those in use today, although preferably the process would be online or automated in some similar fashion. The qualification could rely on the credibility of the prospective Accredited Investor, as is generally done today, or could include additional details that could be used for verification. Further, the process could require higher levels of proof, such as uploading documentation for more assurance. While certainly the wallet or blockchain account could be registered as accredited, as mentioned previously, an even simpler method may be to deposit a seed amount of AZUR into that wallet or blockchain account.

An important aspect of this invention is that AZUR transfers will need to be governed. This is a nearly ideal application for distributed blockchain technology. For example, the Ethereum blockchain allows for the creation of special accounts, called smart contracts, that can send/receive cryptocurrency and execute logic. As shown below, an Ethereum smart contract could govern AZUR transfers by checking the status of the sender and the intended recipient. If both the sender and the intended recipient are Accredited Investors (e.g., both already hold some AZUR), then the transfer can proceed unabated. If the intended recipient cannot be confirmed as an Accredited Investor (and is not a coin exchange as describe above), then the AZUR is returned to the sender (the transfer fails). In one implementation, we envision that potential AZUR recipients who are not yet qualified, must go through the qualification process described above. Note that the network alone (the blockchain) is governing all transfers without 3rd party involvement or complication.

In another possible embodiment, as shown below, rather than block the AZUR transfer to a recipient that is not an Accredited Investor (holds no AZUR), then the smart contract could facilitate a coin exchange to a general currency such as Ether or Bitcoin, and then convey that general currency to the recipient.

Coin exchanges may involve one or more organizations, like market makers, who actually would exchange the AZUR for Ether or Bitcoin. Of course that market maker would need to be qualified as an Accredited Investor, in order to receive the AZUR.

1. A method comprising:
receiving, by a computing device, a transaction for a blockchain, wherein the transaction comprises an indication of a unit of a cryptocurrency and an indication of a recipient of the unit, wherein the cryptocurrency is associated with a class;
determining, based on the transaction, that the recipient comprises a member of the class; and
adding, based on the determination that the recipient comprises the member of the class, the transaction to the blockchain.

2. The method of claim 1, wherein the method further comprises determining that a sender of the unit comprises a member of the class; and
wherein the adding the transaction to the blockchain is further based on the determination that the sender comprises a member of the class.

3. The method of claim 1, wherein the determining that the recipient comprises a member of the class comprises determining that the recipient is in possession of at least a fraction of a unit of the cryptocurrency.

4. The method of claim 1, wherein the class comprises at least one of Accredited Investors or Qualified Investors.

5. The method of claim 1, wherein the determining that the recipient comprises a member of the class comprises determining, using a smart contract of the blockchain, that the recipient comprises a member.

6. The method of claim 1, wherein the method further comprises:
receiving, by the computing device, a second transaction for the blockchain, wherein the second transaction comprises an indication of a second unit of the cryptocurrency and an indication of a second recipient of the second unit; and
determining that the second recipient does not comprise a member of the class.

7. The method of claim 6, wherein the method further comprises exchanging, based on the determining that the second recipient does not comprise a member of the class, the second unit of the cryptocurrency for a unit of another cryptocurrency.

8. The method of claim 7, wherein the method further comprises transferring, to the second recipient, the unit of the second cryptocurrency, wherein the transferring the unit of the second cryptocurrency comprises generating another blockchain transaction, wherein the another blockchain transaction comprises an indication of the second recipient and an indication of the unit of the second cryptocurrency.

9. The method of claim 1, wherein the adding the transaction comprises digitally signing at least a portion of the transaction using a private key associated with the recipient; and
wherein the determining the recipient comprises the member of the class comprises decrypting, using a public key, the at least a portion of the transaction and determining, wherein the public key is associated with the class.

10. The method of claim 1, wherein the method further comprises:
generating, based on the determining that the recipient comprises a member of the class, an account associated with the cryptocurrency; and
depositing, based on the determining that the recipient comprises a member of the class, at least a portion of a unit of the cryptocurrency in the account.

11. The method of claim 1, wherein the method further comprises:
receiving a request to transfer units of the cryptocurrency to the recipient;
determining, based on the request, that the recipient comprises a member of the class; and
transferring, based on the determination that the recipient comprises a member of the class, the units of the cryptocurrency to the recipient.

12. The method of claim 1, wherein the method further comprises transmitting, at time intervals and to the recipient, a request for confirmation of qualification for membership in the class.

13. The method of claim 12, wherein the method further comprises:
receiving, at the time intervals, the confirmation of the qualification for membership in the class; and
transferring, to the recipient and based on the receiving the confirmation, one or more units of the cryptocurrency.

14. The method of claim 1, wherein the adding the transaction comprises sending an indication of the transaction to a plurality of nodes of the blockchain.

15. An apparatus comprising a processor and a memory, the memory storing computer-executable instructions which, when executed by the processor, cause the apparatus to perform the method recited in claim 1.
